(19) United States
(12) Patent Application Publication
(10) Pub. No.: US 2017/0236448 A1
(43) Pub. Date: Aug. 17, 2017

(54) Educational Learning System

(71) Applicant: LaNita Jewel West, Calumet City, IL (US)

(72) Inventor: LaNita Jewel West, Calumet City, IL (US)

(21) Appl. No.: 15/046,171

(22) Filed: Feb. 17, 2016

(51) Int. Cl. G09B 19/14; G09B 19/16

(52) U.S. Cl. CPC G09B 19/14; G09B 19/167

(57) ABSTRACT

An education and learning system that allows a user to memorize the rules of the road in a fun and engaging manner that allows repetitive testing while maintaining the excitement of learning. A person can practice by themselves or with a group of friends and multiply the fun. The system accommodates a variety of learning styles so that auditory, visual and tactile learners remain engaged during the learning process.

### CROSS REFERENCE TO RELATED APPLICATIONS

None.

### STATEMENT REGARDING FEDERALLY SPONSORED RESEARCH OR DEVELOPMENT

None.

### TECHNICAL FIELD

This disclosure relates to educational learning systems generally, and systems for learning the rules of the road specifically.

### BACKGROUND

Since the dawn of time, educators have searched for ways to make learning and the communication of knowledge easier and more productive. From the days of passing along information from one generation to the next through storytelling, to teaching from books in a classroom, and now even through multimedia and audio visual presentations, learning and the transference of knowledge have always been deemed important to society.

Since different people learn differently, it is important to incorporate a multitude of types of inputs, so that whether the individual is a tactile, visual or auditory learner, they are receiving information in a format that is easily recognizable and assimilated by them. Auditory learners are hearing the questions being read aloud to them and answering the questions. Visual learners are seeing the symbols and question and providing their answers. Tactile learners are enabled to learn by picking up the cards and board game markers to provide answers to questions or match to the game board.

Rote memorization of information is not always effective, especially if it is desired for the information to be retained in long term memory and accessible for years to come. The use of a combination of board games, flash cards, and card games can be quite effective in helping a person to learn information and store information in long term memory.

### SUMMARY

In general, the driver's education system employs various methodologies of learning and testing to insure an individual's knowledge and understanding of the rules of the road. The use of flash cards enables an individual to view and review information by themselves, as well as to test themselves on recollection of the rules of the road. The flash cards are a set of cards with the relevant road symbols on one side of the card, and the definition or explanation of the road symbol on the opposite side of the card. Using the flash card method, an individual can view each symbol and test themselves on their knowledge of each symbol. Flash cards allow frequent reviews of each symbol and sporadic testing of recollection of the information, as well as instant feedback as to correctness of information recalled.

The children's flash cards cover basic symbols and the definitions on the back are short and easy to understand. The adult flash cards cover all of the symbols and provide in-depth explanations or definitions of each symbol.

Using a board game for learning allows players to interact with and compete with other players while learning the rules of the road. The children's version of the board game provides a board with multiple spaces containing only the road symbols that have to be matched with the game markers held by each child. The adult version of the board game has both a symbol and a definition on each space and requires the person to match the corresponding marker containing the symbol and definition to the correct space on the board. The challenge of the board game is to complete the matching of the markers with the board spaces as quickly as possible, and faster than other players.

The card game is another multi-player learning method that allows players to interact and test each other's knowledge of the rules of the road while competing against each other for the highest number of cards answered correctly. In the children's version of the card game, a second player shows the front side of each card to the player containing a symbol and a short question. The answer to the question on the back of the card is concealed by the second player until after the first player provides their answer to the question, then revealed to determine whether the answer provided is correct or not. In an advanced version of the card game, a symbol and several questions relevant to the symbol are provided on the front of the card. The second player shows the front of the card to the first player who must answer each of the questions before the answers on the back are revealed by the second player. The player with the most questions answered correctly wins the game.

Certain advantages of the system and methods include multiple methods of learning information, immediate feedback on correctness of answers provided, the ability to learn individually, or in a group setting, as well as the ability to play and learn simultaneously.

Unless otherwise defined, all technical and scientific terms used herein have the same meaning as commonly understood by one of ordinary skill in the art. Although methods and materials similar or equivalent to those described herein can be used in the practice or testing of any described embodiment, suitable methods and materials are described below. In addition, the materials, methods, and examples are illustrative only and not intended to be limiting. In case of conflict with terms used in the art, the present specification, including definitions, will control.

The foregoing summary is illustrative only and is not intended to be in any way limiting. In addition to the illustrative aspects, embodiments, and features described above, further aspects, embodiments, and features will become apparent by reference to the drawings and the following detailed description and claims.

### BRIEF DESCRIPTION OF DRAWINGS

The present embodiments are illustrated by way of the figures of the accompanying drawings, which may not necessarily be to scale, in which like references indicate similar elements, and in which:

FIG. 1 is the flash card game description.

FIG. 2 is the flash card game instructions.

FIGS. 3-7 are illustrative examples of the adult flash cards.

FIG. 8 is the children's flash card game description.

FIG. 9 is the children's flash card game instructions.

FIGS. 10-12 are illustrative examples of the children's flash cards.

FIG. 13 is the adult card game description.

FIG. 14 is the adult card game instructions.

FIGS. 15-17 are explanations of various embodiments of the card game.

FIGS. 18 and 19 are illustrations of the adult card game.

FIG. 20 is the description of the children's card game.

FIG. 21 is the instructions for the children's card game.

FIGS. 22 and 23 are illustrations of the children's card game.

FIG. 24 is the description of the adult board game.

FIG. 25 is the instructions for the adult board game.

FIG. 26 is an illustration of the adult board game.

FIG. 27 is an illustration of the markers for the adult board game.

FIG. 28 is the description of the children's board game.

FIG. 29 is the instructions for the children's board game.

FIG. 30 is an illustration of the children's board game.

FIGS. 31 and 32 are illustrations of the markers for the children's board game.

### DETAILED DESCRIPTION OF ILLUSTRATIVE EMBODIMENTS

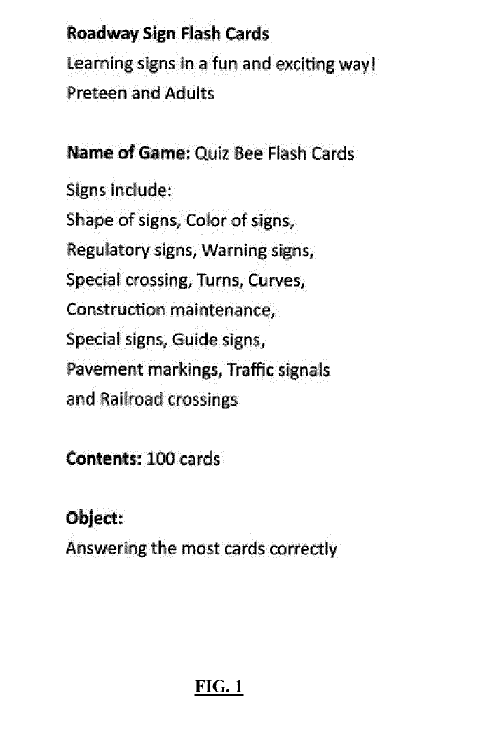

FIG. 1 is an illustrative example of adult flash cards that test your knowledge relevant to driving under the influence, or DUI.

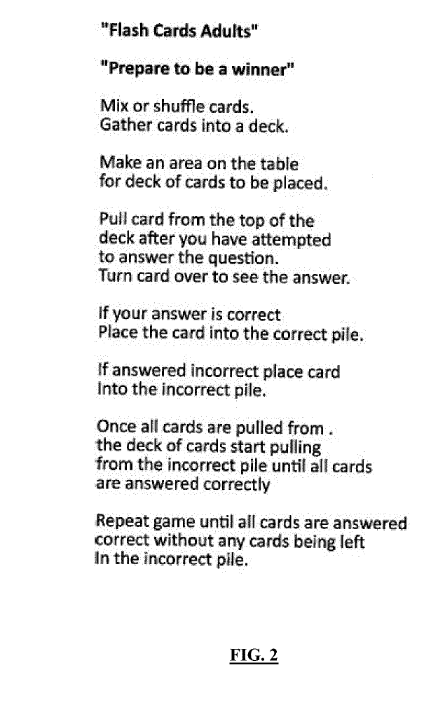

FIG. 2 is an illustrative example of adult flash cards relevant to scenarios typically provided on the driver's exam.

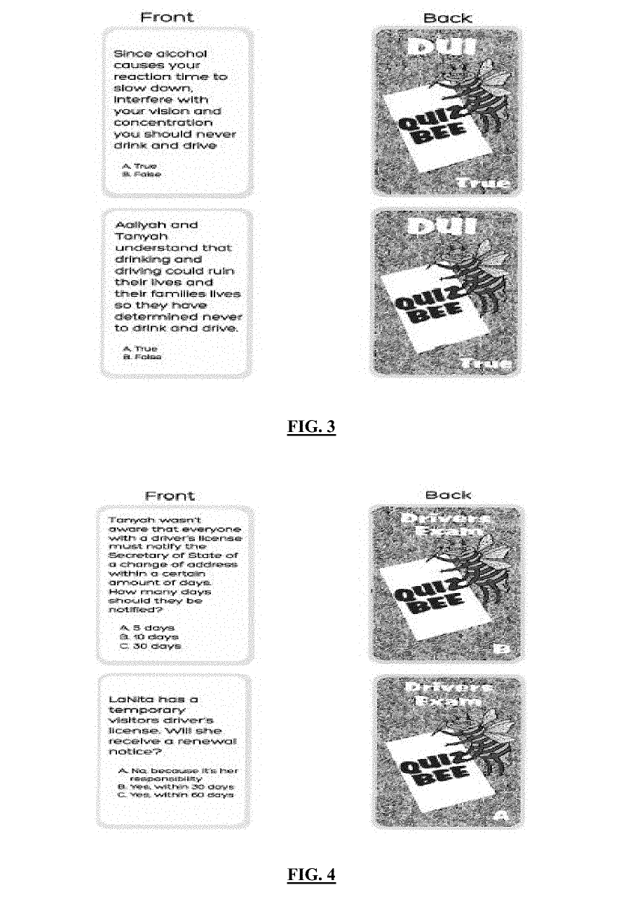

FIG. 3 is an illustrative example of adult flash cars that test your knowledge of how various driving scenarios should be handled.

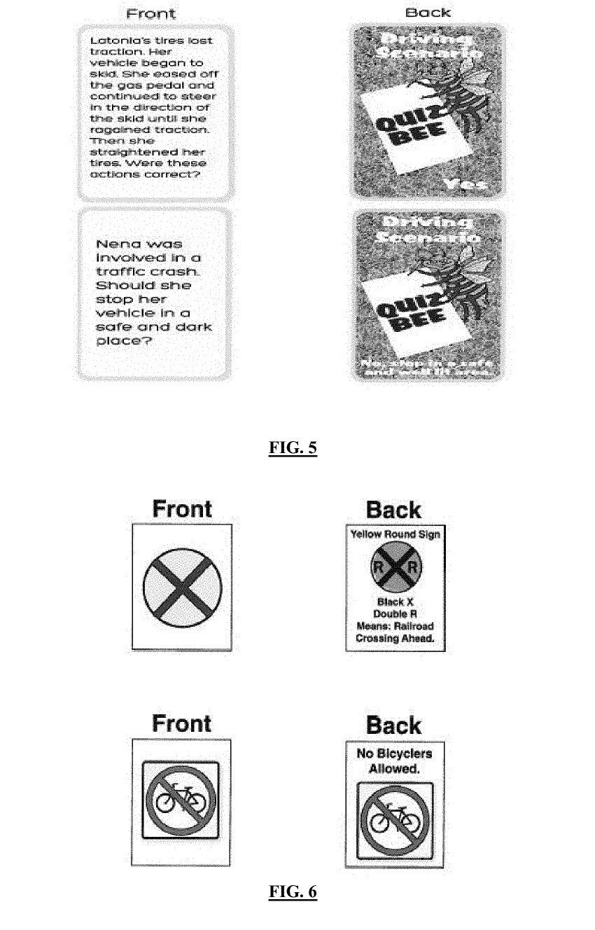

FIGS. 4 and 5 illustrate the content displayed on the sign flash cards for adults.

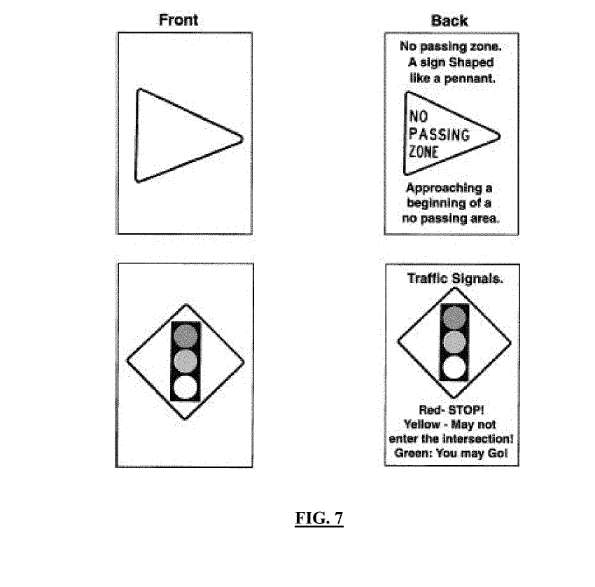

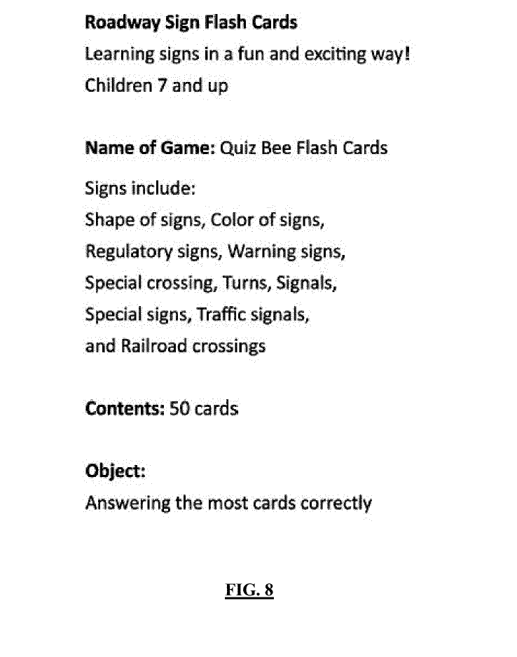

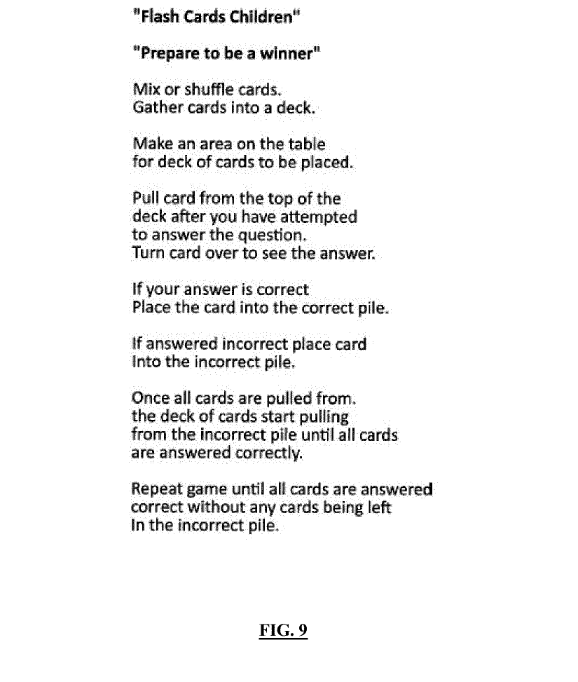

FIGS. 6, 7 and 8 illustrate the contents of the front and back of the signs flash cards for children.

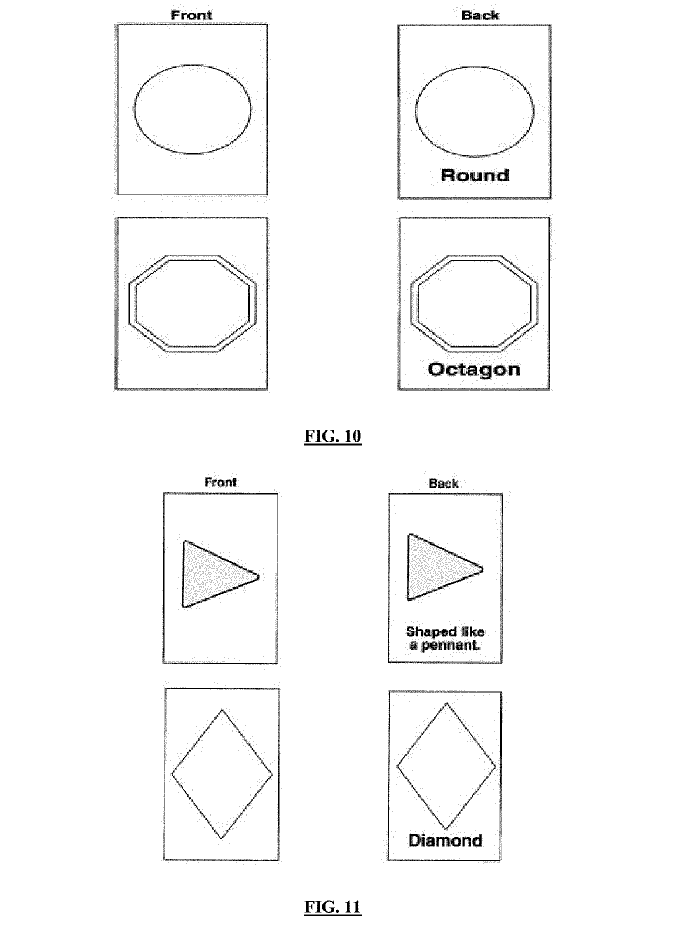

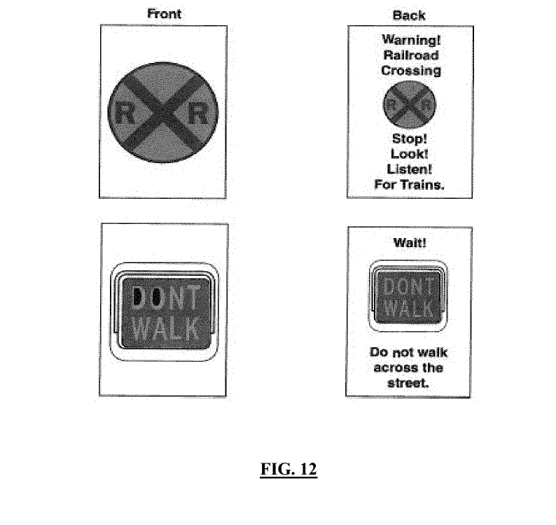

FIGS. 9 and 10 illustrate the questions on the front, along with the answers on the back of the adult card game.

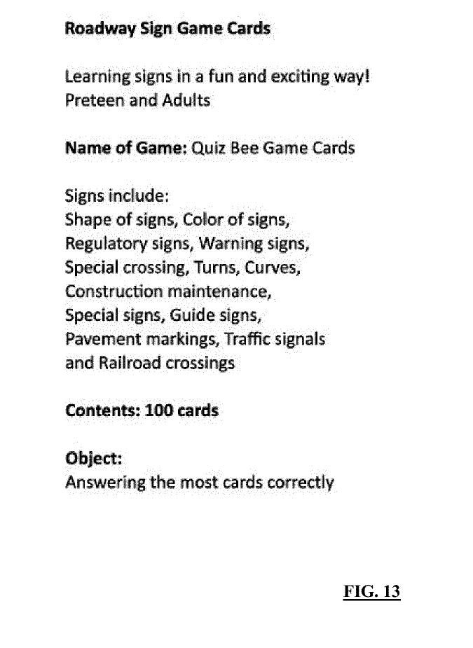

FIGS. 11 and 12 illustrate the traffic signs and questions on the front of the children's cards, along with the answers on the back of the cards in the children's card game.

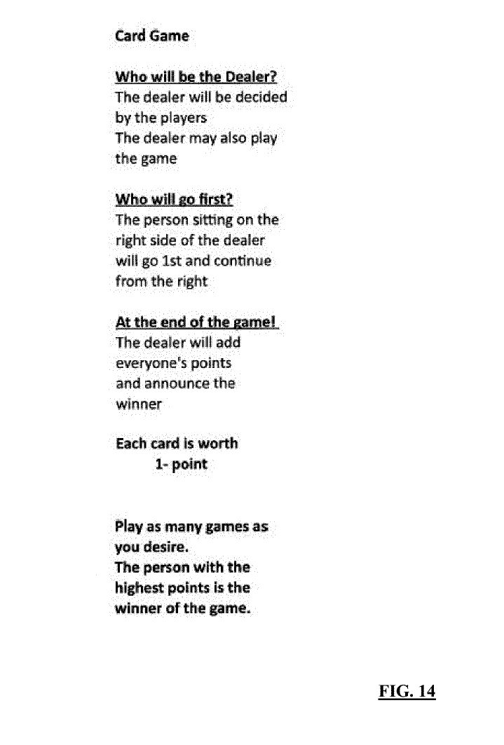

FIG. 13 displays the layout of the adult board game.

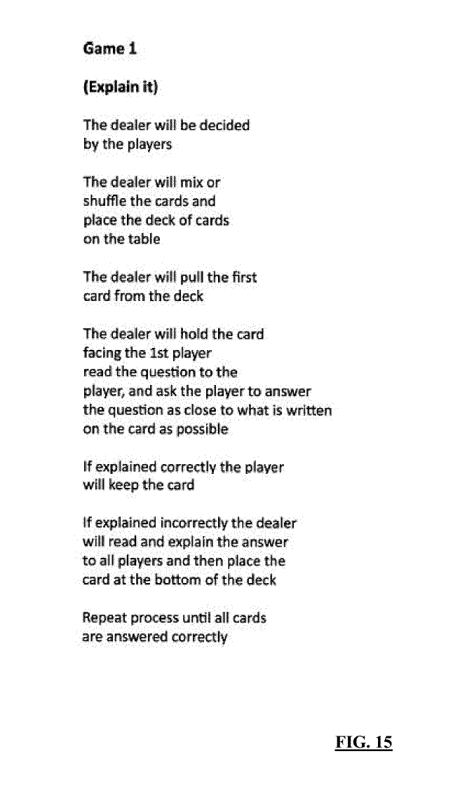

FIGS. 14 and 15 display several examples of the markers that are to be placed onto the correct spaces of the adult board.

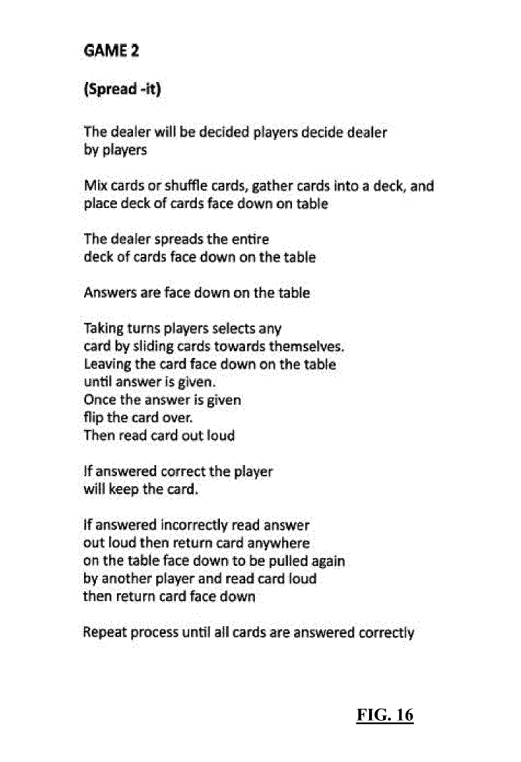

FIG. 16 displays the layout of the children's board game.

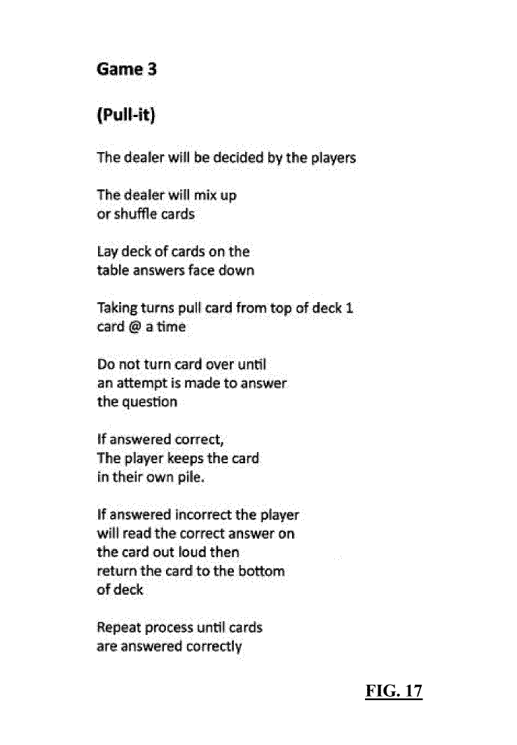

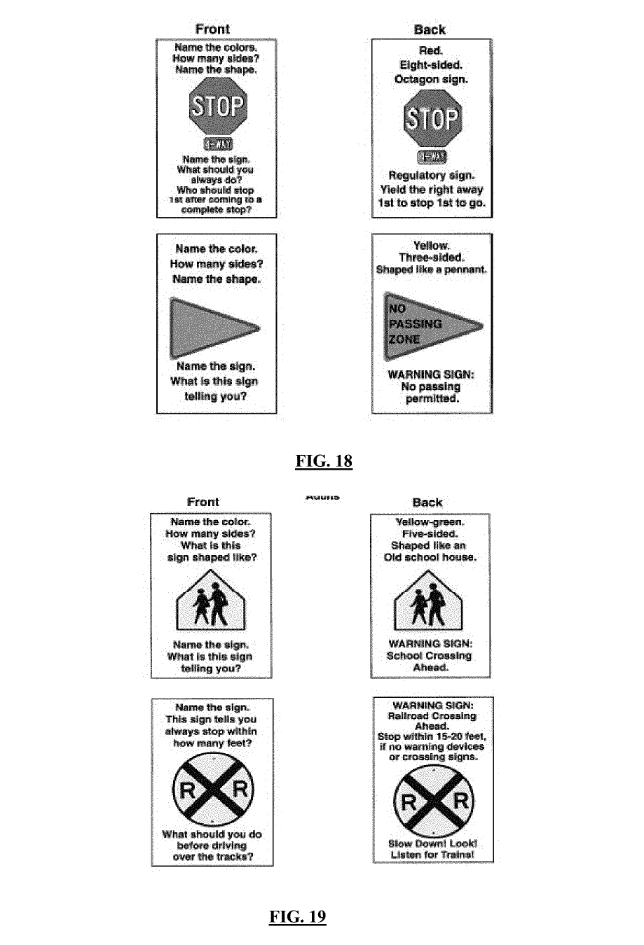

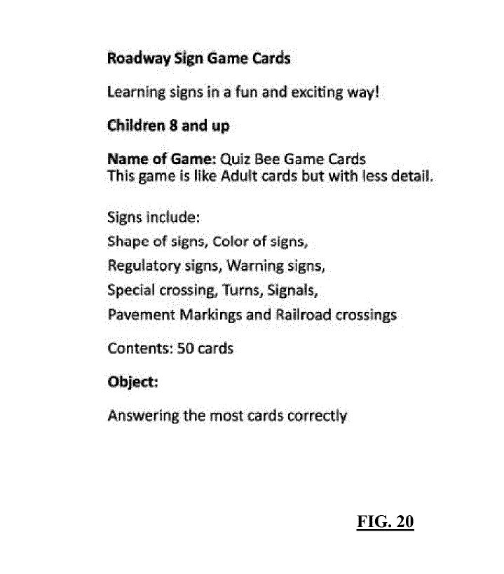

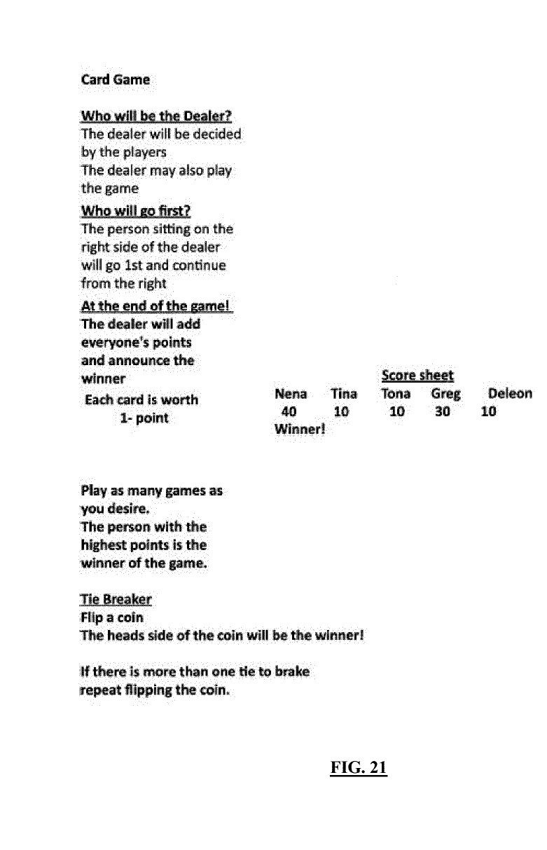

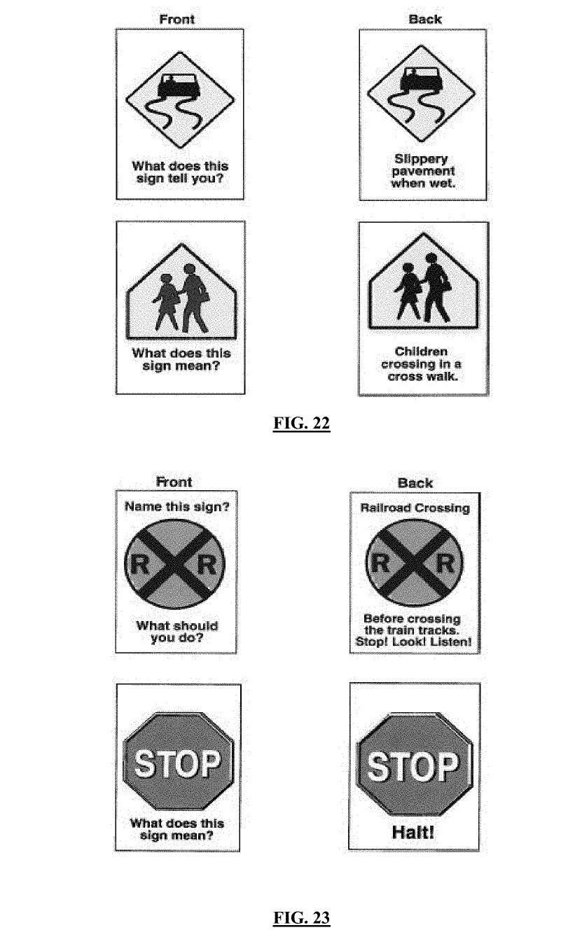

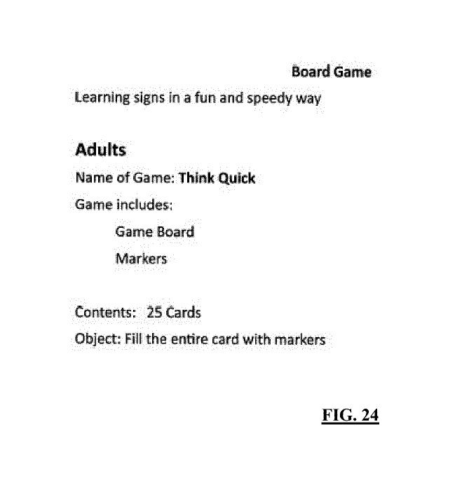

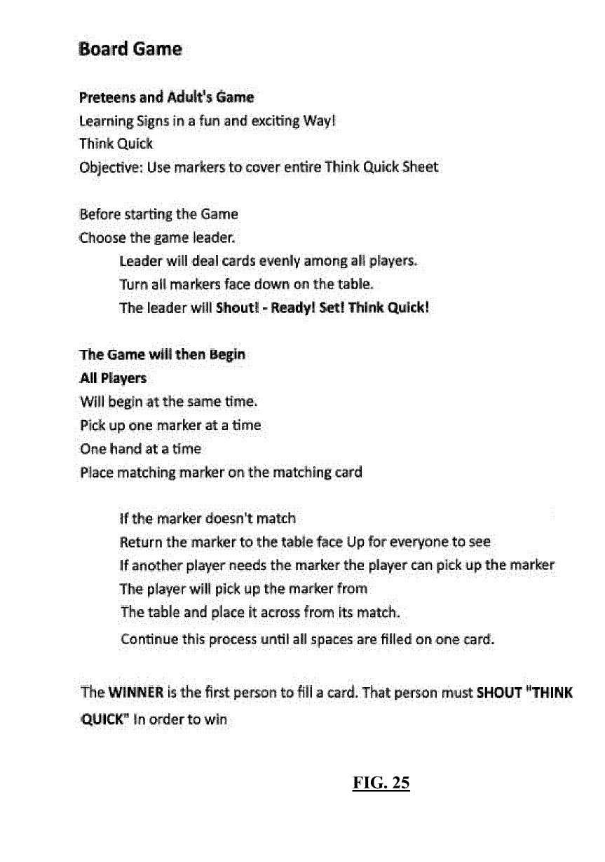

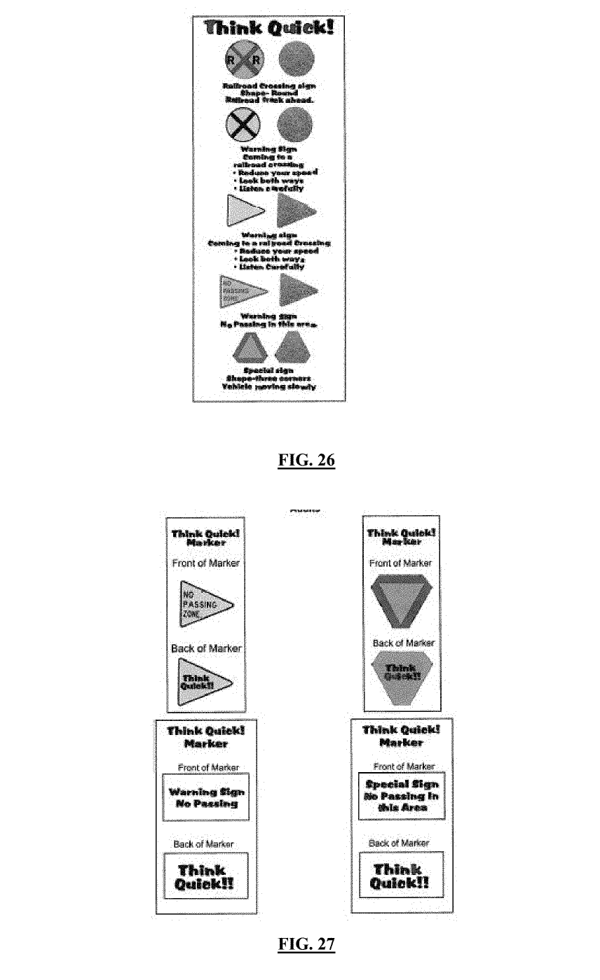

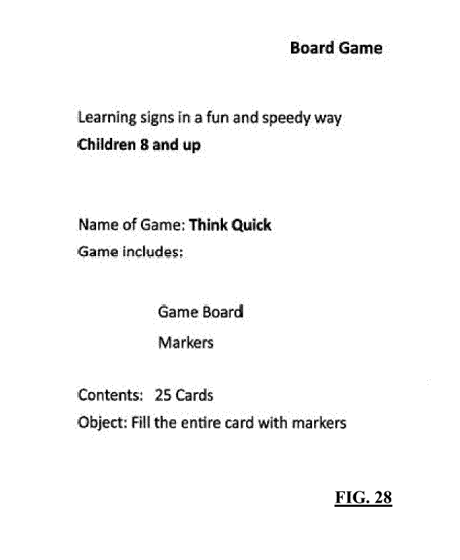

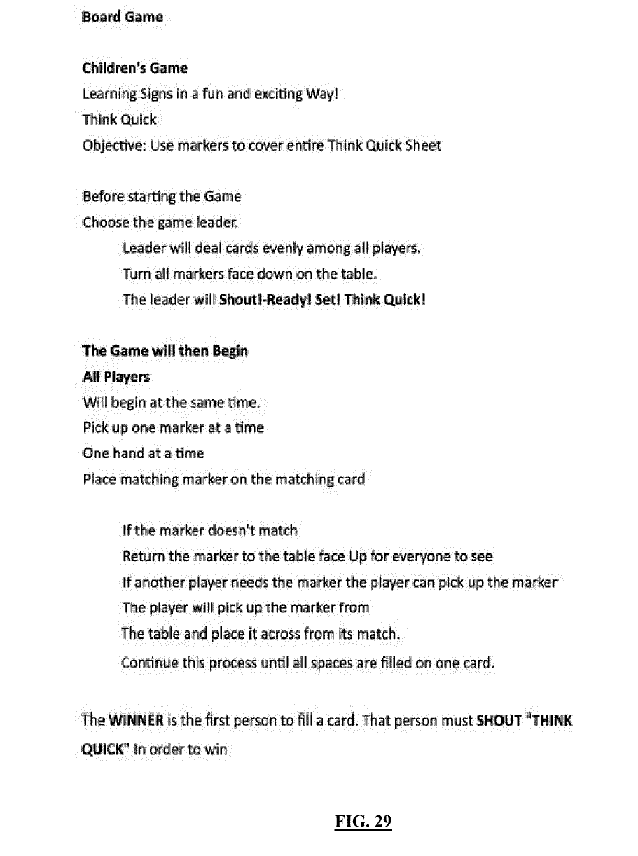

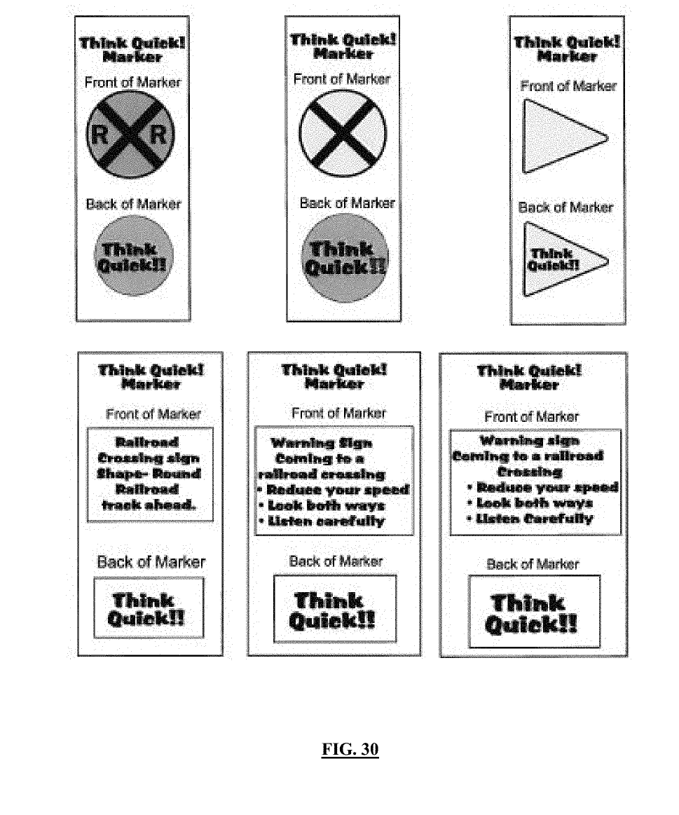

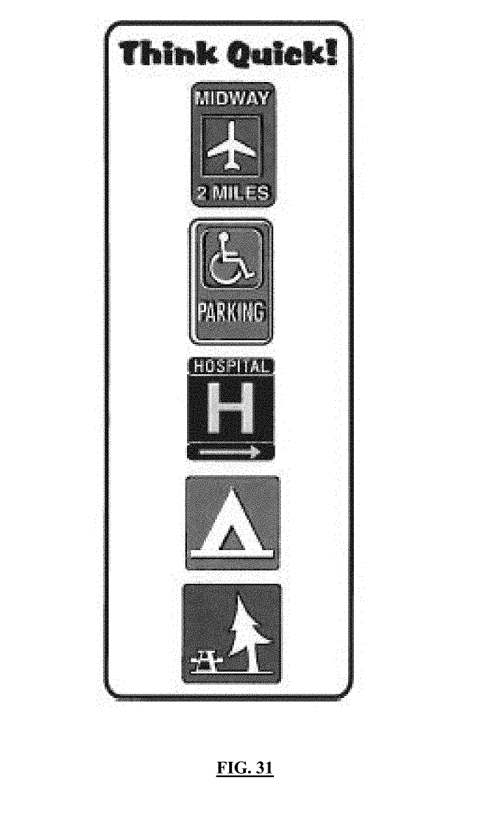

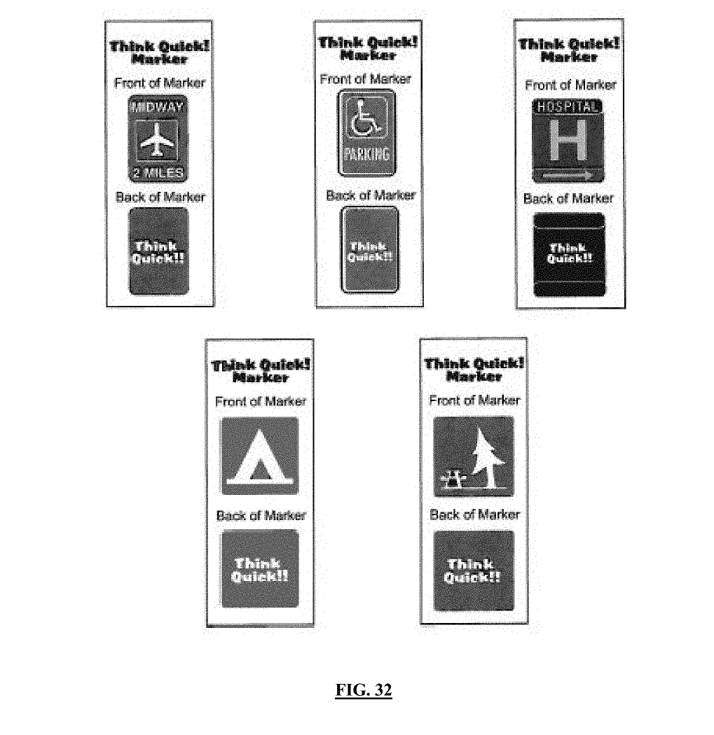

FIG. 17 displays several examples of the markers that are to be matched in the appropriate space on the children's board game.

### DETAILED DESCRIPTION

The educational learning system provides a variety of fun and engaging games for aiding in learning the rules of the road. Each game adds various elements to the learning process and may appeal to different types of learners. Whether playing solo with flash cards, or competing for the fastest time in matching the markers on the board game with a group of friends, the constant immersion in the rules of the road information using auditory, visual and tactile learning greatly enhances the learning process.

The flash cards can be used by one or more persons to review questions on the front of the card, and provide the answers out loud before turning the flash card over to the back to reveal the correct answer.

The flash cards game consists of sets of one hundred flash cards that allow the individual to test their knowledge of shapes of signs, colors of signs, regulatory signs, warning signs, special crossing signs, turn and curve signs, construction signs, special signs, guide signs, pavement markings, traffic signals and railroad crossing signs. The object of the game is to get the most number of cards correct.

In an exemplary embodiment of the flash card game, the flash cards can be shuffled and gathered into a deck of cards. The deck of cards is then placed with answer side down on a flat surface. The player draws one card a time and attempts to answer the question before turning the card over to reveal or confirm the answer. If the answer is correct, the flash card is placed in a correct pile. If the answer is incorrect, the flash card is placed in an incorrect pile. The player continues drawing flash cards until the draw deck is empty. Once the draw deck is empty, the player continues drawing from the incorrect pile and providing answers until there are no more cards in the incorrect pile. The game can be repeated until all of the cards are answered correctly without any cards being placed in the incorrect pile.

In an alternate embodiment the cards can display international roadway symbols and the questions translated into various languages including Spanish, Japanese and Chinese. The cards can also be adapted to translate only the English words into various languages for use by non-native English speaking drivers.

The card games can be used by groups of people to test each other's recollection of the rules of the road.

In an exemplary embodiment of the teen/adult board game, two or more players are dealt a game card by the pre-selected game leader. The game markers are placed on the table face down, and each player picks up a game marker and matches it to the appropriate space on their game card until all the spaces on their card are filled. If the selected marker does not match any spaces on their card, the player returns the marker to the table face up and picks up a new marker. The first player to fill the spaces in their card with the matching marker is the winner.

The board games can also be used to test an individual's knowledge of road signs as well as to practice rapid recollection and rapid symbol matching and placement.

A number of illustrative embodiments have been described. Nevertheless, it will be understood that various modifications may be made without departing from the spirit and scope of the various embodiments presented herein. For example, the markers for the children's game could be interchanged with the markers for the adult board game. Accordingly, other embodiments are within the scope of the following claims.

What is claimed is:

1. An educational learning system for learning drivers exam related information, where an individual or group of individuals can learn by playing games that teach and reinforce the rules of the road comprising; one or more flash card games, and one or more board games used in combination to memorize and learn signs, shapes and colors of driving related rules for the drivers exam.

2. The learning system of claim 1 wherein the flash card game decks are tailored to children aged 7 and up and help them learn traffic sign shapes and colors.

3. The learning system of claim 1 wherein the flash card game decks are tailored to testing preteens and adults knowledge of traffic sign types, shapes, and colors.

4. The learning system of claim 1 wherein the deck of flash cards can be used to play three different multi-player games to test each players knowledge of the rules of the road.

5. The learning system of claim 1 wherein the board game tests knowledge of traffic sign shapes and colors for children ages 8 and up.

6. The learning system of claim 1 wherein the board game tests the marker matching skills of preteens and adults.

7. The system of claim 6 further comprising a means for speed testing knowledge of the rules of the road through timed or competitive play.

8. An educational learning system and method for learning the rules of the road, the method comprising the steps of:
a. providing a player with age appropriate decks of flash cards for memorizing the rules of the road;
b. providing instructions that allow a variety of games to be played with each deck of flash cards;
c. providing instructions for tracking progress in memorizing the rules of the road; and
d. providing a player with age appropriate rules of the road board games for multiple players to increase the variety game objectives and overall enjoyment of the learning process.
